(19) United States
(12) Patent Application Publication
(10) Pub. No.: US 2009/0059108 A1
(43) Pub. Date: Mar. 5, 2009

(54) MULTI-DOMAIN VERTICAL ALIGNMENT LIQUID CRYSTAL DISPLAY PANEL, PIXEL ARRAY STRUCTURE AND DRIVING METHODS THEREOF

(75) Inventors: Chien-Chung Kuo, Taichung County (TW); Chien-Chung Lee, Tainan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: WINTEK CORPORATION, Taichung (TW)

(21) Appl. No.: 12/198,106

(22) Filed: Aug. 25, 2008

(30) Foreign Application Priority Data
Aug. 30, 2007 (TW) 96132224

(51) Int. Cl. G02F 1/1343; G02F 1/133; G02F 1/1368

(52) U.S. Cl. 349/37; 349/139; 349/33; 349/43

(57) ABSTRACT

A multi-domain vertical alignment (MVA) liquid crystal display panel including an active device array substrate, an opposite substrate and a liquid crystal layer is provided. The active device array substrate has a plurality of pixel electrodes and a plurality of auxiliary electrodes, wherein each pixel electrodes has at least a slit and each auxiliary electrode is disposed corresponding to the slit. The opposite substrate is disposed above the active device array substrate and the opposite substrate has a common electrode disposed between the active device array substrate and the opposite substrate. The liquid crystal layer is disposed between the active device array substrate and the opposite substrate. The above-mentioned multi-domain vertical alignment liquid crystal display panel has high aperture ratio and rapid response.

### CROSS-REFERENCE TO RELATED APPLICATION

This application claims the priority benefit of Taiwan application serial no. 96132224, filed on Aug. 30, 2007. The entirety of the above-mentioned patent application is hereby incorporated by reference herein and made a part of this specification.

### BACKGROUND OF THE INVENTION

1. Field of the Invention

The present invention relates to a liquid crystal display panel (LCD panel) and driving methods thereof, more specifically, the present invention relates to a multi-domain vertical alignment (MVA) LCD panel and driving methods thereof.

2. Description of Related Art

At present, market demands LCDs with characteristics of high contrast ratio, no gray scale inversion, little color shift, high color richness, high color saturation, quick response and wide viewing angle and etc. Currently, wide viewing angle can be achieved by various technologies, such as TN LCD panel plus wide viewing angle film, in-plane switching (IPS) LCD, fringe field switching (FFS) LCD and multi-domain vertically alignment (MVA) LCD and so on.

In the case of MVA LCD of prior art, since protrusions or slits disposed on pixel electrodes may allow liquid crystal molecules to arrange in a plurality of directions to obtain a plurality of different alignment domains, the MVA LCD can meet wide viewing angle requirements.

FIG. 1 is a partial sectional view of a conventional MVA LCD panel. As shown in FIG. 1, the MVA LCD panel 100 includes an active device array substrate 110, an opposite substrate 120 and a liquid crystal layer 130 disposed between the two substrates 110 and 120. The active device array substrate 110 comprises the pixel electrode 112 formed thereon, and the opposite substrate 120 comprises the common electrode 122 formed thereon. Meanwhile, in order to allow the MVA LCD panel 100 to achieve wide viewing angle effect, pixel electrode 112 has at least one slit 114 (only one shown in FIG. 1), so that liquid crystal molecules in the liquid crystal layer 130 are arranged into a plurality of alignment domains. Generally, the size of the slits 114 may affect the display effect of the MVA LCD panel 100. Specifically, the greater the size of the slits 114, the larger the distortion of the electric field E above the slits 114, and the quicker the response of liquid crystal molecules. However, since the inclined direction of the liquid crystal molecules above the slits 114 is difficult to control, light leakage phenomenon is likely to occur. For a normally black mode, the abnormal inclination of liquid crystal above the slits 114 may form disclination, and results in restricted aperture ratio of the MVA LCD panel 100. In other words, the greater the size of the slits 114, the more reduction in the aperture ratio of the MVA LCD 100 is resulted. On the other hand, when smaller size slits 114 are used, although the aperture ratio of the MVA LCD panel 100 can be increased, the response of liquid crystal molecules slows down accordingly.

Therefore, how to balance the aperture ratio and response of the MVA LCD panel 100 is still an important issue.

### SUMMERY OF THE INVENTION

The present invention provides a MVA LCD panel having high aperture ratio and rapid response.

The present invention provides a driving method for the MVA LCD panel to increase the aperture ratio and response of the MVA LCD panel.

The present invention also provides a pixel array structure having high aperture ratio and rapid response.

The present invention also provides a driving method for the pixel array structure to increase the aperture ratio and response.

The present invention also provides a pixel structure having high aperture ratio and rapid response.

The present invention provides a MVA LCD panel, which includes an active device array substrate, at least one auxiliary electrode, an opposite substrate and a liquid crystal layer. The active device array substrate comprises a plurality of pixel electrodes, and each of the pixel electrodes comprises at least a slit; and the auxiliary electrode is disposed corresponding to the slits. The opposite substrate is disposed above the active device array substrate, and the opposite substrate has a common electrode between the opposite substrate and the active device array substrate. The liquid crystal layer is disposed between the active device array substrate and the opposite substrate.

In an embodiment of the present invention, the pixel electrodes are disposed above the auxiliary electrode.

In an embodiment of the present invention, the pixel electrodes are disposed under the respective auxiliary electrode.

In an embodiment of the present invention, the liquid crystal molecules of the liquid crystal layer located above the respective pixel electrodes are controlled through the respective pixel electrodes; and the liquid crystal molecules of the liquid crystal layer located above the auxiliary electrode are controlled through the auxiliary electrode.

The present invention also provides a driving method for driving the above-mentioned MVA LCD panel. The driving method includes inputting a first driving voltage to the pixel electrodes to drive the liquid crystal molecules above the pixel electrodes, respectively; and inputting a second driving voltage to the auxiliary electrode to drive the liquid crystal molecules above the auxiliary electrode, respectively.

In an embodiment of the present invention, after the first driving voltage is inputted to the pixel electrodes, the second driving voltage is then input to the auxiliary electrode.

The present invention also provides a pixel array structure including a plurality of scan lines, a plurality of data lines and a plurality of pixel units. The pixel units are electrically connected to the corresponding scan lines and data lines, and the respective pixel units include a first active device, the pixel electrode, a second active devices and the auxiliary electrode. The pixel electrode is electrically connected to one of the scan lines and one of the data lines through the first active device. When the first active device controlled by the corresponding scan line is turned on, the first active device enables the pixel electrode connecting with the corresponding data line. The auxiliary electrode is electrically connected to one of the scan lines and one of the data lines through the second active device. When the second active device controlled by the corresponding scan line is turned on, the second active device enables the auxiliary electrode connecting with the corresponding data lines.

In an embodiment of the present invention, the first active device is a N type transistor, and the second active device is a P type transistor.

In an embodiment of the present invention, the first active device is a P type transistor, and the second active device is an N type transistor.

In an embodiment of the present invention, the pixel array structure further includes the common line and the third active device. The common line is coupled to the common voltage source, and the third active device is electrically connected to the previous level scan line. When the third active device controlled by the previous level scan line is turned on, the third active device enables the auxiliary electrode connecting with the common line.

In an embodiment of the present invention, the first active device includes N type transistor, and the second active device and the third active device include P type transistors.

In an embodiment of the present invention, the first active device and the third active device are N type transistors, and the second active device is P type transistor.

In an embodiment of the present invention, the first active device is P type transistor, and the second active device and the third active device are N type transistors.

In an embodiment of the present invention, the first active device and the third active device are P type transistors, and the second active device is N type transistor.

The present invention also provides a driving method for driving the above-mentioned pixel array structure. The driving method includes sequentially inputting scan signals to the scan lines, so as to sequentially turn on the first active device and the second active device controlled by the same scan line; and sequentially inputting an image data to the pixel electrodes and the auxiliary electrode through the data lines.

In an embodiment of the present invention, the scan signal has a positive half-cycle signal and a negative half-cycle signal.

The present invention also provides a pixel structure including the pixel electrode, at least an auxiliary electrode, the first active device and the second active device. The pixel electrode has at least one slit, and the auxiliary electrode is disposed corresponding to the slits. The first active device is electrically connected to the pixel electrode, and the second active device is electrically connected to the auxiliary electrode.

In an embodiment of the present invention, the pixel electrode may be disposed above or under the auxiliary electrode.

In an embodiment of the present invention, the liquid crystal molecules of the liquid crystal layer located above the pixel electrodes are controlled through the pixel electrodes; while the liquid crystal molecules of the liquid crystal layer located above the auxiliary electrode are controlled through the auxiliary electrode.

Since the auxiliary electrode in the present invention is disposed corresponding to the slits of the pixel electrodes, the liquid crystal molecules located above the slits are controlled by the auxiliary electrode. In this way, the response of the liquid crystal molecules in the MVA LCD panel and the aperture ratio of the MVA LCD panel are enhanced.

In order to the make the aforementioned and other objects, features and advantages of the present invention comprehensible, a preferred embodiment accompanied with figures is described in detail below.

### BRIEF DESCRIPTIONS OF DRAWINGS

FIG. 1 is a sectional view of a conventional MVA LCD panel.

FIG. 2 is a sectional view of the MVA LCD panel according to an embodiment of the present invention.

FIG. 3A and FIG. 3B schematically illustrated driving methods of the MVA LCD panel according to an embodiment of the present invention.

FIG. 4 is a partial diagram of the pixel array structure according to an embodiment of the present invention.

FIG. 5 is a time sequence chart of the scan signal according to an embodiment of the present invention.

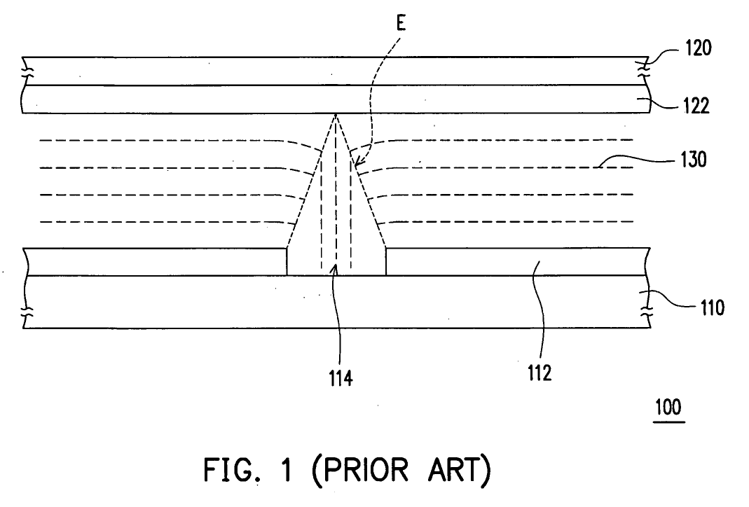

### DESCRIPTION OF EMBODIMENTS

In the MVA LCD panel, the slits or alignment protrusions, which are used to control liquid crystal molecules to perform multi-domain alignment, often cause reduced aperture ratio. In order to reduce negative effect (i.e. the reduced aperture ratio phenomenon) that slits contribute to reduced aperture ratio, the present invention uses the auxiliary electrode corresponding to the slits to increase the aperture ratio of the MVA LCD panel.

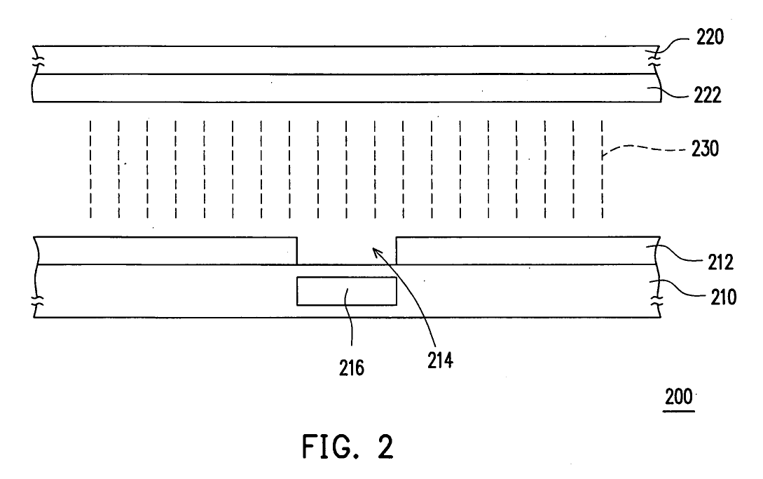

FIG. 2 is a partial sectional view of the MVA LCD panel of an embodiment of the present invention. Referring to FIG. 2, a MVA LCD panel 200 includes the active device array substrate 210, the opposite substrate 220, at least one auxiliary electrode 216 and the liquid crystal layer 230. The active device array substrate 210 has a plurality of pixel electrodes 212, wherein the pixel electrode 212 has at least one slit 214 (for example, only one slit is shown in the present embodiment), and the auxiliary electrode 216 is disposed corresponding to the slits 214. The opposite substrate 220 is disposed above the active device array substrate 210, and the opposite substrate 220 has a common electrode 222. The common electrode 222 is disposed between the opposite substrate 220 and the active device array substrate 210. The liquid crystal layer 230 is disposed between the active device array substrate 210 and the opposite substrate 220.

As shown in FIG. 2, the pixel electrode 212 is disposed above the auxiliary electrode 216, for example. In an alternative embodiment, the pixel electrode 212 is disposed under the auxiliary electrode 216. It is noted that the liquid crystal molecules of the liquid crystal layer 230 located above the pixel electrodes 212 are controlled by the pixel electrodes 212; and the liquid crystal molecules located above the auxiliary electrode 216 are controlled by the auxiliary electrode 216.

In the present embodiment, the auxiliary electrode 216 is disposed corresponding to the slits 214 on the pixel electrodes 214. Therefore, the liquid crystal molecules above the slits 214 can be controlled by the auxiliary electrode 216. For the MVA LCD panel 200, the situation that the arrangement of the liquid crystal molecules above the slits 214 is hard to control can be improved. Furthermore, in a normally black mode MVA LCD panel 200, since the arrangement of direction of the liquid crystal molecules located above the slits 214 can be controlled by the auxiliary electrode 216, the disclination phenomenon occurred at the slits 214 may be improved. In other words, if the slits 214 are enlarged in order to increase the response of the liquid crystal molecules, the display quality of the MVA LCD panel 200 is still not likely to be degraded (i.e. the aperture ratio is not significantly reduced).

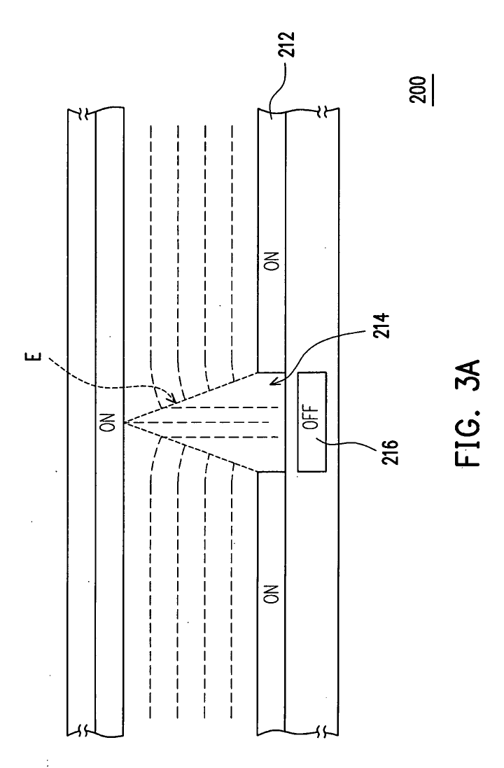

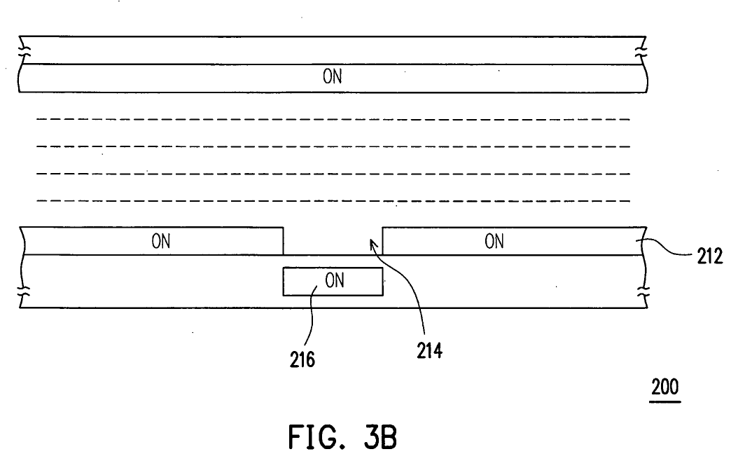

Specifically, the above-mentioned MVA LCD panel 200 may be driven with a driving method below so as to provide rapid response and good display quality. FIG. 3A and FIG. 3B schematically illustrate the driving method of the MVA LCD panel of an embodiment of the present invention. Referring to FIG. 3A, the driving method of the MVA LCD panel 200, for example, includes inputting the first driving voltage to the pixel electrodes 212 first to drive the liquid crystal molecules above the pixel electrodes 212. At this time, distribution of the electric field E at the edge of the slits 214 and the region above of the slits 214 is driven, which can drive the liquid crystal molecules above the pixel electrode 212 to arrange as required. Since the slits 214 have appropriate size, the deformation degree of the electric field E is enough to allow the liquid crystal molecules above the pixel electrode 212 to show the required arrangement quickly and correctly.

Referring to FIG. 3B, the second driving voltage is input to the auxiliary electrode 216 to drive the liquid crystal molecules above the auxiliary electrode 216. In the present embodiment, after the first driving voltage is input to the pixel electrodes 212, the second driving voltage is then input to the auxiliary electrode 216, so that a portion of the liquid crystal molecules above the slits 214 show the required arrangement. Thus, the liquid crystal molecules above the pixel electrode 212 may be controlled by the pixel electrode 212, while the liquid crystal molecules above the slits 214 may be controlled by the auxiliary electrode 216.

In an embodiment of the present invention, after the first driving voltage is input to the pixel electrodes 212, the second driving voltage is input to the auxiliary electrode 216 before the first driving voltage is ended. In an alternative embodiment of the present invention, after the first driving voltage is inputted completely, the second driving voltage is then input to the auxiliary electrode 216. In other words, the input of the first driving voltage and the second driving voltage may overlap at a portion of time, or not overlap at all.

As a whole, the display quality of the MVA LCD panel 200 may not likely be affected by the slits 214. In the mean time, the size of the slits 214 is not limited, which is helpful to increase the response of liquid crystal molecules in the MVA LCD panel 200.

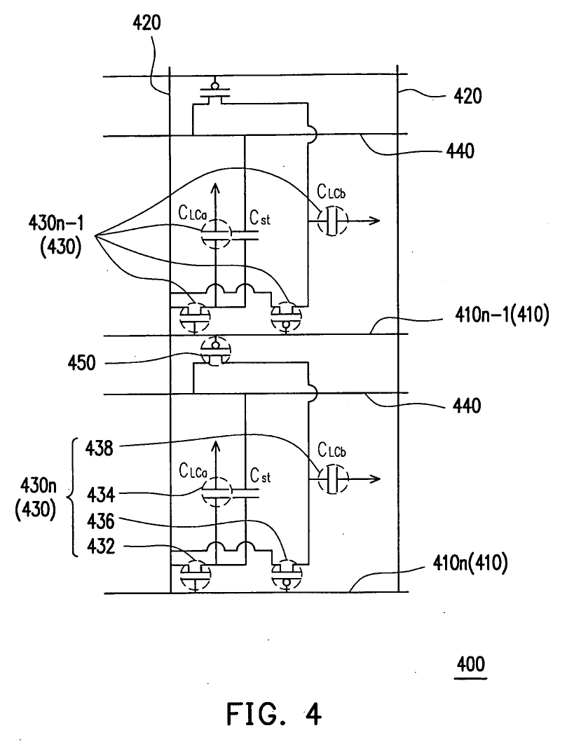

In order to express the spirit of the present invention more clearly, a pixel array structure is provided below. FIG. 4 is a sectional diagram of the pixel array structure of an embodiment of the present invention. Referring to FIG. 4, the pixel array structure 400 includes a plurality of scan lines 410, a plurality of data lines 420 and a plurality of pixel units 430. The pixel units 430n are electrically connected to the corresponding scan lines 410n and data lines 420, and the pixel unit 430n includes the first active device 432, the pixel electrode 434, the second active device 436 and the auxiliary electrode 438. The pixel electrode 434 is electrically connected to the corresponding scan line 410n and the data line 420 through the first active device 432. When the first active device 432 is controlled by the corresponding scan line 410n to be enabled, the first active device 432 enables the pixel electrode 434 connecting with the corresponding data line 420. In addition, the auxiliary electrode 438 is electrically connected to the corresponding scan line 410n and the data line 420 through the second active device 436. When the second active device 436 controlled by the corresponding scan line 410n is turned on, the second active device 436 enables the auxiliary electrode 438 connecting with the corresponding data line 420.

In the present embodiment, the first active device 432 is a N type transistor, and the second active device 436 is a P type transistor. In other embodiments, the first active device 432 is a P type transistor, and the second active device 436 is an N type transistor.

Particularly, the pixel array structure 400 includes the common line 440 and the third active device 450. The common line 440 is coupled to a common voltage source, and the third active device 450 are electrically connected to the previous level scan line 410n−1. When the third active device 450 controlled by the previous level scan line 410n−1 is turned on, the third active device 450 enables the auxiliary electrode 438 connecting with the common line 440. Specifically, when the pixel unit 430n−1 connected to the previous level scan line 410n−1 is turned on, the auxiliary electrode 438 and the common line 440 are connected to each other via the third active device 450.

It is noted that the third active device 450 may be either N type transistor or P type transistor. For example, the combinations of the first active device 432, the second active device 436 and the third active device 450 are listed below. When the first active device 432 is N type transistor, both of the second active device 436 and the third active device 450 may be P type transistors. In an alternative embodiment of the present invention, when the first active device 432 is N type transistor, the second active device 436 is P type transistor and the third active device 450 is N type transistor. In addition, when the first active device 432 is P type transistor, both of the second active device 436 and the third active device 450 are N type transistors. In other embodiment of the present invention, when the first active device 432 is P type transistor, the second active device 436 is N type transistor and the third active device 450 is P type transistor.

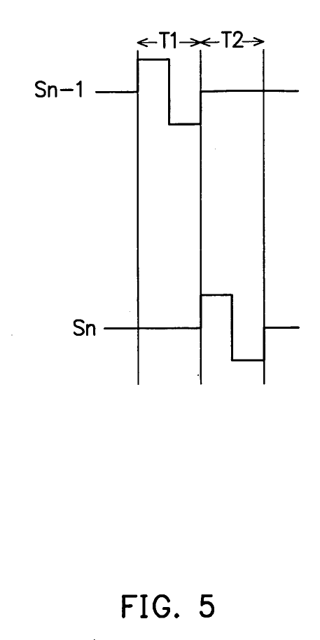

The driving method of the pixel array structure 400 will be described later. FIG. 5 is a time sequence chart of the scan signal of an embodiment of the present invention. Referring to FIG. 4 and FIG. 5, the driving method includes sequentially inputting the scan signal Sn−1 and the scan signal Sn to the scan line 410n−1 and the scan line 410n. When the scan signal Sn is input to the scan line 410n, the first active device 432 and the second active device 436 controlled by the scan line 410n are turned on in sequence. At this time, the image data is input to the pixel electrode 434 and the auxiliary electrode 438 in sequence through the data line 420.

Next, the driving method of the pixel unit 430n will be used as an example to describe the present invention in detail. Referring to FIG. 4 and FIG. 5, within time T1 and T2, the scan signal Sn−1 and the scan signal Sn are respectively input to the scan line 410n−1 and the scan line 410n in sequence. The scan signal Sn−1 and the scan signal Sn both have positive half-cycle signal and negative half-cycle signal. Within time T2, the scan signal Sn with positive half-cycle signal and negative half-cycle signal may turn on the first active device 432 and the second active device 436 controlled by the scan line 410n in sequence. Therefore, the image data transmitted by the data line 420 may be input to the pixel electrode 434 and the auxiliary electrode 438 in sequence. When the structure design of the LCD panel is as the MVA LCD panel 200 of the above embodiment, quick response of liquid crystal molecules and good display quality may be achieved.

It should be noted that the first active device 432 and the second active device 436 are turned on in sequence. And the fore section of the scan signal Sn in FIG. 5 is positive half-cycle signal, and the rear section of the scan signal Sn in FIG. 5 is negative half-cycle signal. In FIG. 5, the first active device 432 in the present embodiment is an N type transistor, and the second active device 436 is a P type transistor. Such combination can allow the second active device 436 to be turned on after the first active device 432 is turned on. Of course, in other embodiments, when the first active device 432 is a P type transistor, and the second active device 436 is an N type transistor, the scan signal Sn can be designed as that the fore section of the scan signal Sn is negative half-cycle signal and the rear section is positive half-cycle signal.

In addition, within time T1, i.e. the time during the pixel unit 430n−1 connected to the previous level scan line 410n−1 is displaying images, the third active device 450 of the pixel unit 430n is turned on. At this time, the auxiliary electrode 438 and the common line 440 may be connected to each other via the third active device 450, so that the voltage of the auxiliary electrode 438 and the voltage of the common line 440 are substantially the same. In this way, the display quality problem due to the fact that the voltage of the pixel electrode 434 is affected by the voltage of the auxiliary electrode 438 of a previous image data will be solved.

Since the scan signals Sn−1, Sn input to the scan lines 410n−1, 410n both have positive half-cycle signal and negative half-cycle signal, the third active device 450 may be either N type transistor or P type transistor.

To sum up, in the MVA LCD panel of the present invention, the auxiliary electrode is disposed corresponding to the slits in the pixel electrodes. The liquid crystal molecules above the slits are controlled by the auxiliary electrode, so as to be able to display images accurately. Therefore, the MVA LCD panel of the present invention is not likely to have disclination phenomenon caused by unclear inclined direction of liquid crystal molecules. Furthermore, the MVA LCD panel of the present invention has higher aperture ratio and good display quality. In the mean time, the size of the slits may be enlarged according to practical needs, which can further increase the response of the liquid crystal molecule in the MVA LCD panel.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A multi-domain vertical alignment (MVA) liquid crystal display (LCD) panel, comprising:
an active device array substrate, having a plurality of pixel electrodes, wherein each of the pixel electrodes has at least a slit;
at least an auxiliary electrode, disposed corresponding to the slits;
an opposite substrate, disposed above the active device array substrate, the opposite substrate having a common electrode located between the opposite substrate and the active device array substrate; and
a liquid crystal layer, disposed between the active device array substrate and the opposite substrate.

2. The MVA LCD panel of claim 1, wherein the pixel electrodes are disposed above the auxiliary electrode.

3. The MVA LCD panel of claim 1, wherein the pixel electrodes are disposed under the auxiliary electrode.

4. The MVA LCD panel of claim 1, wherein liquid crystal molecules of the liquid crystal layer located above the pixel electrodes are respectively controlled through the pixel electrodes.

5. The MVA LCD panel of claim 1, wherein liquid crystal molecules of the liquid crystal layer located above the auxiliary electrode are controlled through the auxiliary electrode.

6. A driving method for driving the MVA LCD panel of claim 1, the driving method comprising:
inputting a first driving voltage to the pixel electrodes to drive liquid crystal molecules above the pixel electrodes, respectively; and
inputting a second driving voltage to the auxiliary electrode to drive liquid crystal molecules above the auxiliary electrode, respectively.

7. The driving method of claim 6, wherein after the first driving voltage is input to the respective pixel electrodes, the second driving voltage is then input to the auxiliary electrode.

8. A pixel array structure, comprising:
a plurality of scan lines;
a plurality of data lines;
a plurality of pixel units, electrically connected to one of the scan lines and one of the data lines respectively, each of the pixel units comprising:
a first active device;
a pixel electrode, electrically connected to one of the scan lines and one of the data lines through the first active device, wherein the first active device enable the pixel electrode connecting with the corresponding data line when the first active device controlled by the corresponding scan line is turned on;
a second active device; and
an auxiliary electrode, electrically connected to one of the scan lines and one of the data lines through the second active device, wherein the second active device enable the auxiliary electrode connecting with the corresponding data line when the second active device controlled by the corresponding scan line is turned on.

9. The pixel array structure of claim 8, wherein the first active device is an N type transistor and the second active device is a P type transistor.

10. The pixel array structure of claim 8, wherein the first active device is a P type transistor and the second active device is an N type transistor.

11. The pixel array structure of claim 8, further comprising:
a common line, coupled to a-common voltage source; and
a third active device, electrically connected to a previous level scan line, wherein the third active device enable the auxiliary electrode connecting with the common line when the third active device controlled by the previous level scan line is turned on.

12. The pixel array structure of claim 11, wherein the first active devices comprise N type transistors; and the second active devices and the third active devices comprise P type transistors.

13. The pixel array structure of claim 11, wherein the first active devices and the third active devices are N type transistors; and the second active devices are P type transistors.

14. The pixel array structure of claim 11, wherein the first active devices are P type transistors; and the second active devices and the third active devices are N type transistors.

15. The pixel array structure of claim 11, wherein the first active devices and the third active devices are P type transistors; and the second active devices are N type transistors.

16. A driving method for driving the pixel array structure of claim 9, the driving method comprising:
inputting a scan signal to the scan lines sequentially, so as to sequentially turn on the first active devices and the second active devices controlled by the same scan line; and
inputting an image data to the pixel electrode and the auxiliary electrode sequentially through the data lines.

17. The driving method of claim 16, wherein the scan signal comprises a positive half-cycle signal and a negative half-cycle signal.

18. A pixel structure, comprising:
a pixel electrode, having at least a slit;
at least an auxiliary electrode, disposed corresponding to the slits;
a first active device, electrically connected to the pixel electrode; and
a second active device, electrically connected to the auxiliary electrode.

19. The pixel structure of claim 18, wherein the pixel electrode is disposed above the auxiliary electrode.

20. The pixel structure of claim 18, wherein the pixel electrode is disposed under the auxiliary electrode.

21. The pixel structure of claim 18, wherein liquid crystal molecules of the liquid crystal layer located above the pixel electrode are controlled by the pixel electrode.

22. The pixel structure of claim 18, wherein liquid crystal molecules of the liquid crystal layer located above the auxiliary electrode are respectively controlled by the auxiliary electrode.
